(19) United States
(12) Patent Application Publication
(10) Pub. No.: US 2010/0037833 A1
(43) Pub. Date: Feb. 18, 2010

(54) Tangle-free/ drag-free coiled pet leash

(76) Inventors: Sarah S. Joung, Anaheim, CA (US); Karen M. Weinberg, Irvine, CA (US)

Correspondence Address: Sarah S. Joung, 2012 W. Fathom Lane, Anaheim, CA, 92801, US

(21) Appl. No.: 12/462,544

(22) Filed: Aug. 5, 2009

Related U.S. Application Data
(60) Provisional application No. 61/189,020, filed on Aug. 15, 2008.

(51) Int. Cl. A01K 27/00

(52) U.S. Cl. 119/798

(57) ABSTRACT

A dog leash utilizing a coil of durable material such as polyurethane which contracts and expands according to the distance of the dog from the holder of the leash. This feature minimizes instances of the dog's legs becoming tangled in the leash or the leash dragging on the ground. The coil also provides shock absorption as dog reaches the end of the leash's maximum length. The present invention also utilizes a sheath of fabric covering the coil, shielding the dog from direct contact with the bare coil which may cause irritation, and creates a soft and cushioned handle for the holder of the leash. The fabric also allows for decorative effects which would not be possible with a bare coil.

### CROSS-REFERENCE TO RELATED APPLICATIONS

This application claims the benefit of U.S. Provisional Patent Application No. 61/189,020, which is incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to pet leashes. More particularly, the invention pertains to dog leashes that utilize a durable plastic or other coil which allows the leash to expand and contract without tangling under the dog's feet or dragging along the ground and is also covered in protective fabric chosen for their durability and comfortability for both the dog and handler of the dog. Fabric covering also allows for decorative elements not afforded by an uncovered coil or coil simply coated in plastic.

The invention will be described with reference to leashes used by dog handlers, but persons familiar in the art will recognize that the present invention is applicable to leashes for use by handlers of various pets including cats and other domestic or nondomestic animals.

Many inventions have sought to remedy the problems associated with conventional pet leashes. Use of a standard non-elastic leash such as those consisting substantially of nylon webbing creates a jolting effect for pets as a result of the finite length of the leash. A dog's unexpected sprint followed by an abrupt and oftentimes violent jerk, as the conventional leash reaches its full length, can cause physical harm to the pet's muscles and joints, as well as harm to the arm or shoulder of the holder of the leash. In addition, once the leash has reached its full length, the dog's legs and/or neck can become tangled in the extra slack of the leash. Furthermore, conventional pet leashes often drag on the ground, which adds to wear and tear on the leash; they may also snag on ground features such as roots or rocks.

Over the years, inventions have sought to alleviate such problems. For example, a manually operated retractable leash provides the operator of the leash the ability to control the length of the leash in order to maintain control of the pet's range and reduce sagging of the leash. However, such a leash is also subject to some of the same faults of the conventional leash. Once the length is locked into place, a pet's sudden dash may be abruptly halted, causing harm to the pet's muscles and joints. Furthermore, if the leash is locked into place at a length that is long enough to drag along the ground, the leash can become tangled under the dog's legs or on obstacles on the ground such as trees or bushes. Additionally, the plastic component pieces of retractable leashes may snap under repeated and/or prolonged pulling or jerking; in certain instances, this can cause serious injury to pets or handlers as a result of blunt impact with the spring hook or handle containing the bulky retracting mechanism.

As an alternative, in U.S. Pat. No. 2,911,947, a helical coil of spring steel is used as a leash which can prevent sagging. In U.S. Pat. No. 5,732,663, a stretch leash made of a bungee-like cord material is described. Both leashes can be stretched beyond the original non-tensioned length.

The present invention differs substantially from previous leashes, including those comprised of bungee material or steel coils, by utilizing materials and methods of construction which improve upon the currently existing leashes.

### BRIEF SUMMARY OF THE INVENTION

The present invention provides a new leash construction comprised of an inner material of polyurethane, or other durable plastic, which is coiled in such a way as to give it elastic qualities, such as those of a coil or spring. The construction of the leash is also comprised of an outer fabric which covers the inner coil like a sheath. The fabric sheath is held in place at each end of the coil by stitching the fabric securely to an inner durable material, such as grosgrain ribbon, which is attached to small loops constructed on each end of the coil. The finished leash contains a spring hook at one end for attaching the leash to the pet's collar or harness. A loop handle comprises the other end of the leash. The loop handle may be constructed using the same continuous fabric that sheathes the rest of the leash.

The inner coil may be manufactured from extruded polyurethane; however, other materials could be substituted depending on application and preference (for example, if a metal cable coil is used, a small-gauge steel cable insulated with plastic may be used). The inner coil can be of varying gauge, size, length, and tension, depending on the size of the pets the leash is intended to be used for.

Each end of the coil is turned in to create small loops of varying size depending on preference; the loops may be fused together with heat and/or reinforced with clips constructed of metal or other durable material, to ensure that the loops remain securely in place. Each clip may be of varying size depending on preference. Through each small loop, a strip of durable material, such as grosgrain ribbon, may be stitched into place. These strips may be of varying length and width depending on preference and will be used to stitch the outer fabric of the leash into place.

The fabric which sheathes the inner coil may be cut as a continuous piece of fabric (or various pieces stitched together to create one continuous piece of fabric) of varying width, depending on preference. The width of the fabric will determine how snug the sheath will be against the inner coil. As for the length, the fabric should be cut to ensure that its length is appropriate for the maximum length of the coil in its extended state; the fabric should be cut to match the maximum length of the coil or at least cut longer than the maximum length to ensure that the coil and fabric work together to reinforce the strength of the leash. The cut fabric is stitched together by running a seam lengthwise along the inside of the fabric. The tube is then turned inside-out so as to make visible the preferred side of the fabric. Finally, the coil is passed through the tube in such fashion as to cause the coil to become sheathed in fabric.

The fabric must be chosen for comfort, strength, and degree of elasticity, protecting the coil from general wear and tear as well as providing a protective layer of comfort between the coil and the dog or handler of the leash. Fabrics which are not used in conventional leashes may be utilized with the current invention, since the coil and fabric work together to provide the strength to withstand repeated and prolonged tension from pulling and jerking, allowing the fabric to also serve an ornamental or decorative application, in addition to protecting the inner coil and providing improved comfort over a bare coil. In addition, the fabric protects pet and handler of the leash from irritation of the skin that would result from repeated contact with the bare coil material. As opposed to nylon material (i.e., nylon webbing) or other rough or hard materials used in or as conventional leashes, the fabric in the current invention provides maximum comfort to the dog and the holder of the leash, allowing for prolonged and repeated use.

Once the inner coil is sheathed in fabric, and the fabric lies comfortably flush against the coil so as not to impede the extension and retraction of the finished leash, the ends may be stitched together so as to provide a spring hook on one end and a loop handle on the other. The loop handle may be constructed from fabric of the same material which sheathes the rest of the leash.

### BRIEF DESCRIPTION OF THE SEVERAL VIEWS OF THE DRAWING

FIG. 1 is a side view of the inner components of the finished leash which is a coil, in its non-extended state, with looped ends and clips;

FIG. 2 is a side view of the coil, in its non-extended state, with looped ends and clips shown in FIG. 1, with durable material stitched through each looped end;

FIG. 3 is a side view of the finished leash showing the spring hook and cushioned handle.

### DETAILED DESCRIPTION OF THE INVENTION

Dimensions of the leash vary depending on application. Typical leash may be six feet long at full extension, but in some applications, coil and fabric may be measured so as to extend beyond or under six feet. Contracted length will similarly vary, depending on maximum length desired, coil size (which changes contracted length relative to extended length), and coil tension. For example, a leash for a small to medium size pet may use a coil that has outside diameter of fifteen millimeters with wire diameter of four millimeters. Such coil may be cut at such length so as to stretch to a maximum length accordingly; for example, a coil which is 28 centimeters at rest from end to end, may stretch to approximately six feet when fully extended (including the length of the loop handle).

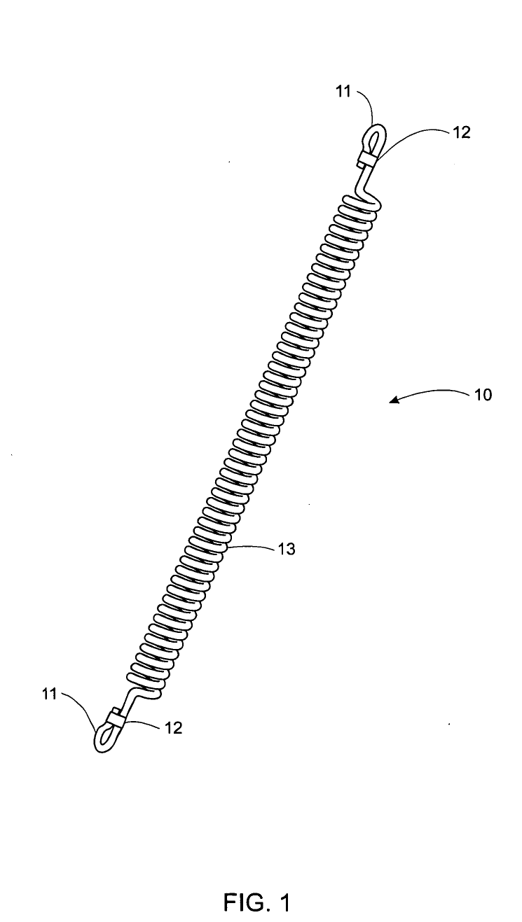

FIG. 1 illustrates the raw inner components 10 of the leash with each coil 13 having looped ends 11, either by being fused together and/or held in place with a clip 12 which is constructed of metal or other durable material. The coil 13 is either commercially available durable plastic, such as polyurethane, or metal coils, of various gauge, coil size, and/or coil length depending on size or weight of the dog the leash is intended to serve or depending on the purpose or preference. Size of looped ends and clips may vary depending on preference. For example, looped ends may be two centimeters in length, with clips measuring one centimeter in length.

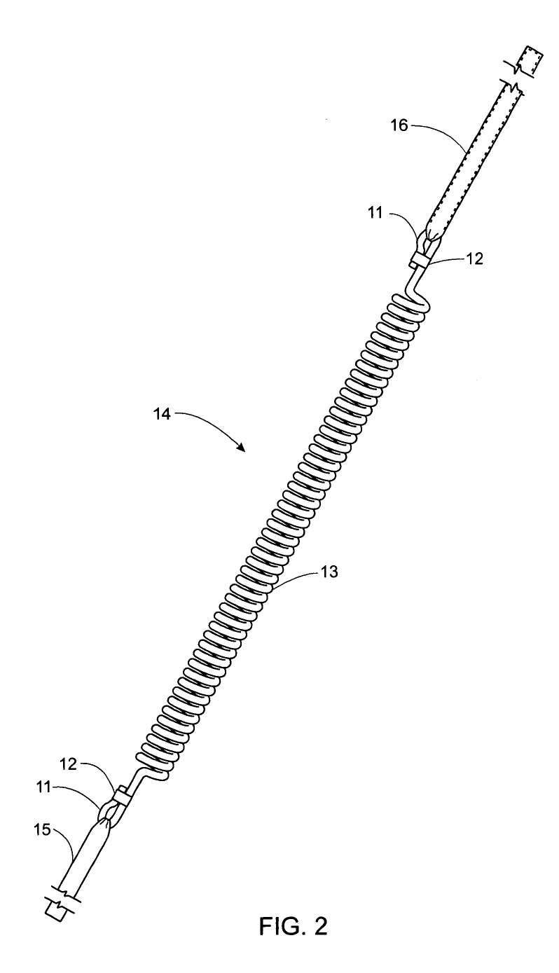

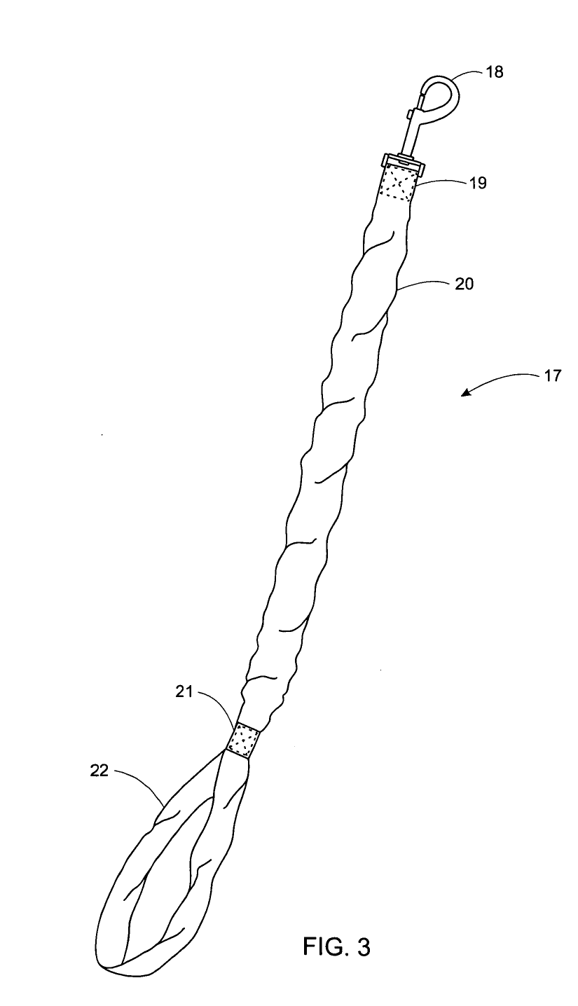

FIG. 2 illustrates the finished inner components 14 of the leash which comprises a strip of fabric 15, which is a durable material, such as grosgrain ribbon, stitched through one of the looped ends 11, and another strip of fabric 16, which is a durable material, such as grosgrain ribbon, stitched through the looped end 11 at the opposite end. The specific lengths and widths of the strips of fabric may be adjusted depending on preference. FIG. 2 illustrates a shorter strip of fabric 15 on one end and a longer strip of fabric 16 on the opposite end. The shorter strip of fabric 15 is sheathed in fabric and serves as the lead to the spring hook 18. It must therefore be cut at such length to ensure that the strip can be comfortably stitched through the looped end 11 as well as through the spring hook 18. The longer strip of fabric 16 need not be of differing length; however, the longer strip of fabric 16 can serve as the interior of the fabric loop handle 22 in the finished leash, illustrated in FIG. 3. In such use, the longer strip of fabric 16 must be cut at such length to ensure that the strip can be utilized for the entire loop handle 22 of the finished leash 17. For added cushion to the finished loop handle 22, the longer strip of fabric 16 may consist of durable material, such as grosgrain ribbon, on one side with a padded backing such as foam or other padded material on the other side.

FIG. 3 illustrates a finished leash 17 sheathed in fabric and comprises a spring hook 18 of durable plastic or metal material on one end. The spring hook 18 is attached to the body of the leash 20 by stitching 19 fabric from one end of the leash (with durable material such as grosgrain ribbon inside) through the spring hook's closed bracket. A loop handle 22 (with durable material such as grosgrain ribbon inside) is stitched 21 to the body of the leash 20 at the opposite end. The hand loop 22 may consist of the same continuous piece of fabric which sheathes the body of the leash 20 and may be formed by stitching a loop at the end opposite the spring hook, as illustrated in FIG. 3. The fabric must be cut long enough to cover all inner components of the coil when the coil is fully stretched, yet cut wide enough to allow the coil to contract and extend with ease without tearing or otherwise causing undue stress to the outer fabric.

What is herein claimed is:

1. A dog leash, comprising:
an inner coil of durable plastic such as polyurethane or small-gauge metal coil;
with each end of the inner coil tucked in to create looped ends, secured in place by fusing with heat and/or use of a clip constructed of metal or other durable material;

2. The leash described in claim 1, wherein a strip of durable material, such as grosgrain ribbon, is stitched through one looped end of the coil and another strip of durable material, such as grosgrain ribbon, is stitched through the other looped end of the coil, and both strips of fabric are stitched to the outer fabric;

3. The leash described in claim 2, wherein the coil is sheathed in durable and decorative fabric, chosen for comfort, strength, degree of elasticity, for protection against irritation, and includes a spring hook on one end for attaching the leash to the dog's collar or harness and a loop handle on the other end for holding the leash.
